(19) United States
(12) Patent Application Publication
(10) Pub. No.: US 2002/0190425 A1
(43) Pub. Date: Dec. 19, 2002

(54) Production of thermoplastic molding compounds using magnesium oxide

(76) Inventors: Peter Ittermann, Lampertheim (DE); Rainer Theysohn, Frankenthal (DE)

Correspondence Address: KEIL & WEINKAUF, 1350 CONNECTICUT AVENUE, N.W., WASHINGTON, DC, 20036, US

(21) Appl. No.: 10/168,715

(22) PCT Filed: Dec. 18, 2000
(86) PCT No.: PCT/EP00/12915

(30) Foreign Application Priority Data
Dec. 23, 1999 (DE) 199 62 570.0

(51) Int. Cl. B29B 7/00

(52) U.S. Cl. 264/211; 264/328.1

(57) ABSTRACT

A process is described for extrusion and/or injection molding of plastics of acrylonitrile-butadiene-styrene (ABS) type or of acrylonitrile-styrene-acrylate (ASA) type, which comprises using a magnesium oxide having a citric acid number of <1500 sec, preferably <800 sec, during the extrusion and/or injection molding, as additive. This process allows the formation of mold deposit during the processing of the plastics mentioned to be reduced to a minimum. The quality of the resultant moldings is increased. There is markedly less need for procedures to clean the processing machinery used.

The present invention relates to the plastics processing sector. More precisely, the present invention relates to a process which uses a particular quality of magnesium oxide to inhibit the production of deposits during extrusion and injection molding of ABS and of ASA plastic parts. The invention also relates to thermoplastic moldings obtainable by this process

The processes known as extrusion and injection molding are frequently used to produce moldings from a wide variety of thermoplastics, and the two steps are also often used in succession, extrusion producing pellets which are then used in obtaining a molding by injection molding. A feature shared by these two processes is that they comprise the melting of the plastics and the discharge of the resultant melt through dies, under pressure.

In the case of almost all plastics, some decomposition is observed here as a consequence of processing al high temperature and of applying pressure during the procedure of discharge from the extrusion or injection-molding apparatus. Plastics of the type ABS (acrylonitrile-butadiene-styrene) and ASA (acrylonitrile-styrene-acrylate) are among those affected, and this is one of the reasons for the occurrence of what is known as mold deposit. Alongside the decomposition products, this mold deposit also comprises oligomers and polymers of the starting monomers used and found within the plastic, and also other constituents associated with vapor-emission. This mold deposit collects firstly within the mold itself, within the dies and within the vents, thus disrupting the molding process and the extrusion process.

Secondly, deposits frequently occur on the molded components themselves. These are often problematic simply due to their dark color, and moreover if the mold deposit has an oily consistency it can often disrupt printing, adhesive bonding or electroplating. A consequence is a loss of quality in the molded components.

To remove the mold deposit, the production process has to be interrupted after a certain length has been extruded or a certain number of injection-molding procedures has been completed, for mechanical cleaning of the mold, the dies and the vent ducts. This stops the machine and causes loss of production, and moreover the cleaning procedure requires manpower. In addition, a certain percentage of the moldings obtained has to be rejected, and this is of course undesirable.

It would therefore be useful to be able to carry out extrusion and injection molding in a way which produces only very little mold deposit.

It is an object of the present invention, therefore, to provide a process which allows this formation of mold deposit to be suppressed or even prevented during the processing of ABS or ASA in the processes described.

We have found that this object is achieved by means of a process for extrusion and/or injection molding of plastics of acrylonitrile-butadiene-styrene (ABS) type or of acrylonitrile-styrene-acrylate (ASA) type, which comprises using a magnesium oxide having a citric acid number of <1500 sec, in extrusion and/or injection molding, as additive.

It has been found that the use of magnesium oxide can greatly reduce or even completely suppress the formation of mold deposit and of oily deposits. The intervals at which the apparatuses are cleaned can be substantially greater, and substantially fewer moldings have to be rejected.

The magnesium oxide which can be used according to the present invention must have a certain activity with respect to acids. More precisely, the magnesium oxide must have basic groups which are available within a certain time for the neutralization of acids. Although the way in which the magnesium oxide acts in the present invention is not precisely known, it may be said that the basic properties mentioned are decisive in the magnesium oxide.

These basic properties are expressed via what is known as the citric acid number, deriving from a test which measures the time taken for a specified amount of citric acid to be neutralized by a specified amount of magnesium oxide. To this end, 2.6 g of citric acid are dissolved in 100 ml of water and added all at once, together with 0.01 g of phenolphthalein, to a stirred dispersion of 1.7 g of magnesium oxide in 100 ml of water. The time taken for the color of the phenolphthalein to change from colorless to pink is measured. The shorter this time, the more readily available are the basic groups for the neutralization of acids. The test described is therefore a measure of the availability of basic groups on the water-wettable surface of the magnesium oxide.

In the context of the present invention, good results are obtained here with magnesium oxide qualities having a citric acid number <1500 sec. Better results could be achieved with magnesium oxide qualities having a citric acid number <800 sec, the best results being achieved with magnesium oxide having a citric acid number <600 sec.

One way of obtaining a magnesium oxide of the quality described is to fire the magnesium oxide without exceeding certain temperatures. The activity here of magnesium oxide fired below 900° C. is generally described by a citric acid number <1500 sec. On firing at <750° C., citric acid numbers <800 sec are achieved, and if the firing procedure is carried out at still lower temperatures it is possible to prepare an oxide having still higher activity. For example, magnesium oxide having a citric acid number <600 sec can be obtained by firing at <700° C.

For the reasons described above, the present invention generally uses magnesium oxide fired at <900° C., preferably <750° C. Still better results are achieved with magnesium oxide fired at <700° C.

The amount of magnesium oxide used is from 0.02 to 10% by weight, preferably from 0.05 to 5% by weight, most preferably from 0.1 to 1% by weight based on the amount of the plastic used.

The use of magnesium oxide having the properties described above thus makes it possible to prevent the formation of mold deposits during extrusion or injection molding of ABS or ASA. Firstly, markedly less formation of mold deposit is observed within the mold, within the dies and within the vents. Secondly, less oily deposit occurs on the moldings, and therefore only a small residual portion of these has to be rejected. In addition, there are improvements to adhesive bonding capability, printability and electroplating capability. It is advantageous to use a finely divided magnesium oxide, since in this way it is possible to obtain plastic parts which have good mechanical properties.

This can be confirmed by determining notch impact strength. Good results for notch impact strength could be achieved when using magnesium oxide of a particle size at which 90% of all of the particles have a diameter <30 μm (d90<30 μm). Better results were achieved using a magnesium oxide with a particle size d90<15 μm, and the best results came from the use of a magnesium oxide with a particle size d90<8 μm.

Plastics in which the described use of magnesium oxide gives the positive results indicated are copolymers of styrene, specifically plastics of acrylonitrile-butadiene-styrene (ABS) type and of acrylonitrile-styrene-acrylate (ASA) type. For the purposes of the present invention, ABS plastics here are those plastics defined in the Draft for the European Standard ISO 2580-1. These are styrene-acrylonitrile copolymers having a continuous phase based on copolymers of styrene/alkyl-substituted styrene and acrylonitrile and having a disperse elastomeric phase predominantly based on butadiene, with some possible admixture of other novel components. These other components may be monomers or polymers of compounds other than acrylonitrile, butadiene and substituted or unsubstituted styrene, and these novel components are present at not more than 30% by weight. If the novel component is a polymer, then this has been dispersed in a matrix made from a styrene-acrylonitrile copolymer. Monomers which may be present are acrylic esters, butadiene, maleic anhydride and other anhydrides, and N-phenylmaleic esters, and other maleic esters.

For the purposes of the present invention, ASA plastics are those plastics defined in the Draft for the European Standard ISO 6402-1. ASA here is a plastic having a continuous phase essentially based on a styrene-acrylonitrile copolymer, and having a disperse elastomeric phase predominantly based on acrylic ester. Other novel components may also be present. If these are monomers other than acrylonitrile, substituted or unsubstituted styrene or acrylic esters, the proportion by weight of these is not more than 30%. If these are polymers, then these polymers not based on acrylonitrile, on substituted or unsubstituted styrene or on acrylic ester are present at not more than 15% by weight. These polymers moreover have been dispersed in a matrix made from a styrene-acrylonitrile copolymer. The monomers mentioned above are acrylic esters, butadiene, maleic anhydride and other anhydrides, or N-phenylmaleic esters or other maleic esters.

The process of the invention may be used in the production of any thermoplastic article or plastic part made from ABS or ASA, these being produced by extrusion or injection molding. Extruded or injection-molded parts of this type are known to the skilled worker, and in the context of the present application it is not possible to provide an exhaustive and comprehensive list. Extruded pellets, semifinished products, and extruded finished products are included, as are moldings, sheets and profiles which can be produced by extrusion or injection molding. These plastic parts and plastic articles which can be obtained by extrusion and/or injection molding by using the process of the present invention are also provided by the invention.

Particularly preferred moldings which can be produced by the process of the invention are injection-molded chip cards and toy building blocks, housings for electrical or electronic parts, for example kitchen machines, shavers, telephones, vacuum cleaners, monitor housings, keyboards, electric lawnmowers, toy railroads, washing machines, dishwashers, refrigerators, parts for the interior of motor vehicles, e.g. center consoles, door side paneling, tachometer housings, ventilator nozzles, buttons and switches, and parts for external use on motor vehicles, for example wheel caps, external mirrors (colored, surface-coated or electroplated), galvanized emblems, radiator grilles, and spoilers.

The present invention is now further illustrated by the examples below.

In examples 1-8 below, Terluran® KR2876/1 ABS polymer (manufacturer: BASF AG) was mixed with the appropriate amount of additive and extruded at 250° C. in a twin-screw ZSK 30 extruder, and pellets were produced from the resultant extrudates. The resultant pellets were introduced into an injection molding machine, melted and then injection-molded in a tensile-bar-weld-line mold. In a mold of this type, this tensile bar is injected from its two ends. The result is that the two melt fronts meet in the middle and give a weld line. Since no vents have been provided, slight mold deposits occur in the vicinity of the weld line, and these allow the formation of mold deposit to be assessed, even after a short period. After 350 shots, the mold was dismantled and the formation of mold deposit assessed.

### EXAMPLE 1 (COMPARATIVE EXAMPLE)

Terluran® KR2876/1 white was injection molded in the injection molding machine described above under the conditions described, without addition of additives. The formation of a hard mold deposit having a brown margin was observed here.

### EXAMPLE 2 (COMPARATIVE EXAMPLE)

Terluran® KR2876/1 white was first extruded without adding MgO, and the resultant pellets processed as described in example 1. Again, the formation of a mold deposit was observed, the amount and the appearance being as in example 1.

### EXAMPLE 3 (COMPARATIVE EXAMPLE)

The procedure was as in example 2, except that 0.5% by weight of dihydrotalcite of the formula [Mg4.5Al2(OH)13]2+[CO3]2-3.5H2O from Kyowa Chemical Industry Company was added. Compared with example 2, the amount of mold deposit was lessened, but a brown margin was still visible.

### EXAMPLE 4 (COMPARATIVE EXAMPLE)

The procedure was as described in example 2, except that 0.5% by weight of CaCO3 having a particle size d85<50 μm was added. After injection molding, it seas observed that a mold deposit had formed and was identical in amount and in appearance to the deposit obtained in example 2.

### EXAMPLE 5 (COMPARATIVE EXAMPLE)

The procedure was as described in example 2, except that 0.5% by weight of ZnO having a particle size d85<5 μm was added. Compared with example 2, the amount of the deposit was lessened, but a brown margin again arose.

### EXAMPLE 6

The procedure was as described in example 2, but 0.5% by weight of MgO was used. This had a particle size d50 of about 2.0 μm and d90 about 7.7 μm, and had been fired at 700° C. After the injection-molding procedure it was established that, in comparison with example 2, the amount of the mold deposit had been markedly reduced, and moreover no brown margin was detectable. The resultant material had a notch impact strength to ISO 179/1eA of 23.3 kJ/m2.

### EXAMPLE 7

The procedure was as described in example 6, but the MgO used had a particle size d50 of about 4.0 μm and d90 about 15 μm. After the injection-molding procedure it was again established that, in comparison with example 2, the amount of the mold deposit had been reduced and there was no longer any occurrence of a brown margin. The notch impact strength of the material to ISO 179/1eA was 19.8 kJ/m2.

### EXAMPLE 8 (COMPARATIVE EXAMPLE)

The procedure was as described in example 6, but the MgO used had been fired at 1200° C. and had a particle size d50 of about 5 μm. In comparison with example 2, a reduction in the amount of mold deposit was established, but the formation of a brown margin was again observed.

### EXAMPLE 9 (COMPARATIVE EXAMPLE)

Terluran® EGP-7 ABS pellets (manufacturer: BASF AG) were extruded in a ZSK 40 extruder using tube tooling, to give tubes of external diameter 21.4 mm and wall thickness 2.0 mm. During a running period of about 30 minutes, a black, oily deposit built up on the upper margin of the annular die. From time to time this was entrained by the extruded tube and led to dark streaks on the upper side of this tube. The contaminated tube sections had to be rejected. It was not possible to clean the die without damaging the soft, melt-like surface of the tube. Removal of the deposit without damaging the tube was also impossible, on each occasion visible lines and streaks appeared on the tube. The effect described is particularly disadvantageous for small-diameter tubes which are wound up after extrusion, where large running lengths are required.

### EXAMPLE 10

The procedure was as described in example 9, but 0.3% by weight of MgO which had been fired at 700° C. was added to the pellets to be extruded. This MgO had a particle size d50 of about 2.0 μm and d90 of about 7.7 μm. The powder was intimately mixed with the pellets, followed by processing in the ZSK 40 extuder. After 30 minutes of running time it was established that the only build-up of deposit was a barely visible deposit on the upper margin of the annular die. However, the amount was so small that this deposit was not entrained by the extruded tube. The resultant tube had satisfactory surface quality.

We claim:

1. A process for extrusion and/or injection molding of plastics of acrylonitrile-butadiene-styrene (ABS) type or of acrylonitrile-styrene-acrylate (ASA) type, which comprises using a magnesium oxide having a citric acid number of <1500 sec and a particle size of d90<30 μm in extrusion and/or injection molding, as additive.

2. A process as claimed in claim 1, wherein the magnesium oxide has been fired at <900° C., preferably <750° C., most preferably <700.

3. A process as claimed in claim 1 or 2. wherein the particle size of the magnesium oxide has values of <15 μm, most preferably <8 μm, and the citric acid number is <800 sec, most preferably <600 sec.

4. An ABS plastic article or ASA plastic article or plastic part which can be produced by the process as claimed in any one of claims 1 to 3, and which comprises a magnesium oxide, as described in any one of those claims.

5. A plastic article as claimed in claim 4 in the form of a pellet.

6. A plastic part as claimed ill claim 4 in the form of a thermoplastic molding.

7. A thermoplastic molding as claimed in claim 6 in the form of an extruded semifinished product or of an extruded finished product, in particular of a sheet, of a profile or of a molding.

8. A thermoplastic molding as claimed in claim 6 in the form of an injection-molded part.

9. An injection-molded part as claimed in claim 8 in the form of a chip card or of a toy building block.

10. An injection-molded part as claimed in claim 8 in the form of an electrical or electronic part, of a part for the interior of a motor vehicle, or of a part for external use on motor vehicles.
